(19) United States
(12) Patent Application Publication
(10) Pub. No.: US 2013/0298119 A1
(43) Pub. Date: Nov. 7, 2013

(54) MANAGEMENT SYSTEM AND METHOD USING THE SAME

(71) Applicants: Ming-Yi HSU, Keelung City (TW); Chien-Kuo HUNG, Taoyuan County (TW); Tien-Chin FANG, Taoyuan County (TW); Chen-Chung LEE, Nantou County (TW)

(72) Inventors: Ming-Yi HSU, Keelung City (TW); Chien-Kuo HUNG, Taoyuan County (TW); Tien-Chin FANG, Taoyuan County (TW); Chen-Chung LEE, Nantou County (TW)

(73) Assignee: Quanta Computer Inc., Tao Yuan Shien (TW)

(21) Appl. No.: 13/603,973

(22) Filed: Sep. 5, 2012

(30) Foreign Application Priority Data
May 2, 2012 (TW) 101115607

(51) Int. Cl. G06F 9/455

(52) U.S. Cl. 718/1

(57) ABSTRACT

A management method for multiple virtual machines (VMs) in a virtualized server is provided. The management method includes steps of: generating a command; determining an extended cluster including N serving VMs and M redundant VMs in response to the command, wherein the N serving VMs are for providing computing services, N is a natural number, and M is an integer greater than or equal to zero; determining an expanding event in response to the command; periodically detecting workload information of the N serving VMs; periodically determining whether the workload information of the N serving VMs satisfies the expanding event; if yes, determining whether M equals zero; if M does not equal zero, activating one of the M redundant VMs to remove one redundant VM and to accordingly add a new serving VM.

This application claims the benefit of Taiwan application Serial No. 101115607, filed May 2, 2012, the subject matter of which is incorporated herein by reference.

### BACKGROUND OF THE INVENTION

1. Field of the Invention

The invention relates in general to a management system and a method using the same, and more particularly to a management system for managing virtual machines (VMs) in a virtualized server and a method using the same.

2. Description of the Related Art

As technologies continue to evolve at a fast pace, computer system hardware virtualization, or referred to as software emulation, is developed for bringing conveniences to the daily life. For example, in applications of infrastructure-as-a-service (IaaS) in cloud computing, hardware virtualization virtually divides computing resources of a physical computer host into multiple virtual machines (VMs). As far as a user is concerned, the physical computer host is equivalent to multiple hosts for simultaneously implementing multiple different application operations.

Therefore, it is critical issue for manufacturers as how to provide a more flexible management method for the current hardware virtualization to further offer business models having enhanced flexibilities.

### SUMMARY OF THE INVENTION

According to an aspect of the present invention, a management system applied to a virtualized server is provided for managing multiple virtual machines (VMs) in the virtualized server. The virtualized server executes a virtualized management code to simulate the VMs. The management system includes a user interface module, a master control module and a system surrogate module. The user interface module provides a user interface, and generates a command in response to a user event. The master control module determines an extended cluster in response to the command. The extended cluster includes N serving VMs and M redundant VMs. The N serving VMs provide computing services through a network path. N is a natural number, and M is an integral greater than or equal to zero. Also in response to the command, the master control module further determines an expanding event associated with workload information of the VMs. The system surrogate module periodically provides a trigger event to drive the master control module to detect the workload information of the N serving VMs, and to drive the master control module to determine whether the workload information satisfies the expanding event. If the workload information satisfies the expanding event, the master control module further determines whether M equals zero. If M does not equal zero, the master control module activates one of the M redundant VMs to remove one redundant and at the same time add a new serving VM, and updates N and M to N+1 and M−1, respectively.

According to another aspect of the present invention, a management method is provided. The management method is applied to a management system of a virtualized server to manage multiple VMs in the virtualized server. The virtualized server executes a virtualized management program to simulate the VMs. The management method includes steps of: providing a user interface and generating a command in response to a user event by a user interface module of the management system; determining an extended cluster by a master control module of the management system in response to the command, wherein the extended cluster includes N serving VMs and M redundant VMs, the N serving VMs provide computing services, N is a natural number and M is an integral greater than or equal to zero; determining an expanding event by the master control module in response to the command, wherein the expanding event is associated with workload information of the N serving VMs; periodically providing a trigger event by a system surrogate module of the management system to drive the master control module to detect the workload information of the N serving VMs; determining whether the workload information stratifies the expanding event by the master control module in response to the trigger event; if the workload information stratifies the expanding event, determining whether M equals zero by the master control module; if the workload information does not satisfy the expanding event, activating one of the M redundant VMs by the master control module to remove one redundant VM and to add a new serving VM, and at the same time updating N and M to N+1 and M−1, respectively.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a management system according to one embodiment of the invention.

FIG. 2 is a schematic diagram of a software stack of a virtualized server 2 according to one embodiment of the invention.

FIG. 3 is a flowchart of a management method according to one embodiment of the invention.

FIG. 4 is a schematic diagram of an extended cluster G.

FIG. 5 is a partial flowchart of a management method according to one embodiment of the invention.

FIG. 6 is a partial flowchart of a management method according to one embodiment of the invention.

FIG. 7 is a partial flowchart of a management method according to one embodiment of the invention.

### DETAILED DESCRIPTION OF THE INVENTION

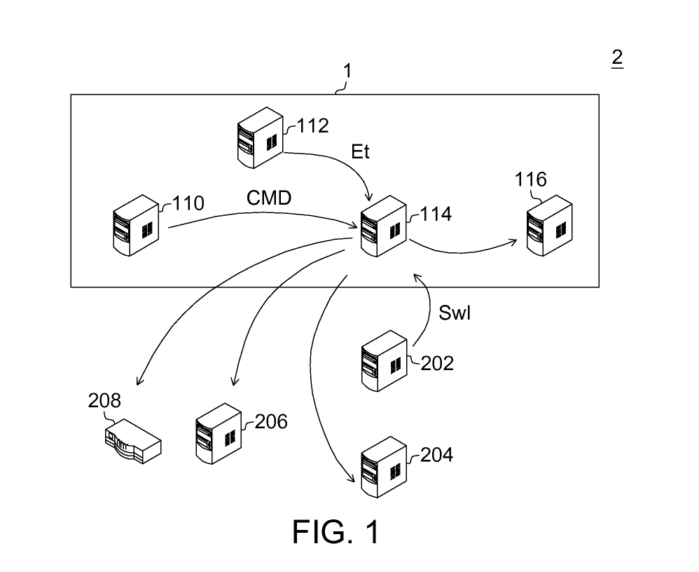

FIG. 1 shows a block diagram of a management system according to one embodiment of the invention. A management system 1 is applied in a virtualized server 2 to manage multiple virtual machines (VMs, not shown) in the virtualized server 2.

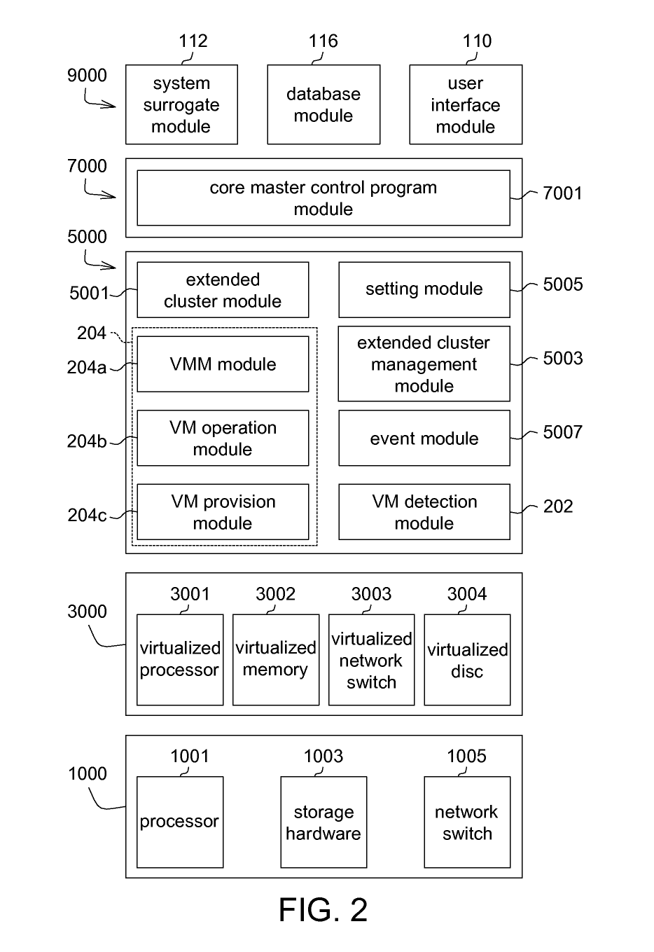

FIG. 2 shows a schematic diagram of a software stack of the virtualized server 2 according to one embodiment of the invention. For example, the virtualized server 2 includes a hardware layer 1000, a hypervisor 3000, a system core software layer 5000, a system core service layer 7000, and an application program layer 9000. The hardware layer 1000 includes hardware including a physical processor 1001, storage hardware 1003 and network hardware 1005. In other words, the hardware layer 1000 may be implemented by any current personal computer hardware or server computer hardware.

The hypervisor 3000 located above the hardware layer 1000 executes related virtualized management programs to correspondingly simulate the VMs on the hardware layer 1000. For example, the hypervisor 3000 may be implemented by Microsoft™ virtualized management software Hyper V. With respect to the VMs, the hypervisor 3000 is correspondingly provided with a virtual CPU 3001, a virtual memory 3002, virtual network switch 3003, and a virtual disc 3004.

The system core software layer 5000 is provided with a VM monitoring module 202 and a VM management module 204. For example, both of the VM monitoring module 202 and the VM management module 204 are application software interfaces provided by a virtualized management program. Through the application software interface provided by the VM management module 204, a core master control program module 7001 of the system core service layer 7000 is allowed to control the virtualized management program in the VM management layer 3000 and the VMs. Similarly, through the application software interface provided by the VM monitoring system 202, the core master control program module 7001 is also allowed to detect workload information Sw1 (e.g., utilization rates of the virtual CPU 3001 and the virtual memory 3002, a network flow of the virtual network switch 3003, or a data access speed of the virtual disc 3004) of the VMs.

For example, the VM management module 204 is implemented by a VMM module 204a, a VM operation module 204b and a VM provision module 204c in the virtualized management software Hyper V. Further, the VMM module 204a is an application programming interface (API) provided by the virtualized management software, so that the core master control program module 7001 in the system core service layer 7000 is enabled to command the virtualized software management in the VM management layer 3000 and the VMs. In response to a call from the core master control program module 7001 in the system core service layer 7000, the VM operation module 204b and the VM provision module 204c perform operations such as booting, shutting down, taking a snapshot, backing up, establishing, deploying, setting or giving a command.

The core software layer 5000 further includes other application software modules for implementing the management system 1 of this embodiment jointly with other software modules in the system core service layer 7000 and the application program layer 9000. Moreover, the core software layer 5000 further includes an extended cluster module 5001, an extended cluster management module 5003, a setting module 5005 and an event module 5007. The system core service layer 7000 includes the core master control program module 7001. The application program layer 9000 includes a database module 116, a system surrogate module 112 and a user interface module 110.

For example, the extended cluster module 5001, the extended cluster management module 5003, the setting module 5005, the event module 5007 and the core master control program module 7001 form a master control module 114 in the management system 1. The master control module 114 interacts with the user interface module 110, the system surrogate module 112 and the database module 116 in the management system 1 to perform associated management operations of the management system 1 of this embodiment.

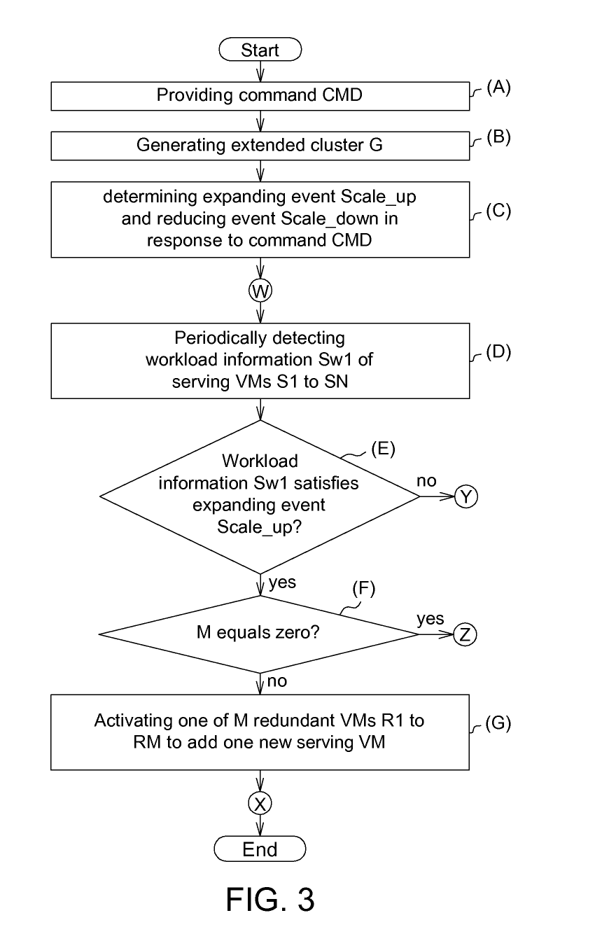

FIG. 3 shows a flowchart of a management method according to one embodiment of the invention. The management method is executed by implementing the management system 1 according to one embodiment of the invention. Operation details shall be given below with reference to FIGS. 1 and 3.

The management method begins with Step (A). In Step (A), the user interface module 110 provides a command CMD in response to a user event. For example, the user interface module 110 provides a user interface for a user of the virtualized server 2. For another example, the user interface is a user console provided via a network interface; the user can trigger a corresponding user event (e.g., a keyboard input or a mouse input) via a corresponding user input interface device (e.g., a keyboard or a mouse) to generate the command CMD. For example, the command CMD selectively indicates information including N number of serving VMs in an extended cluster, M number of redundant VMs, an expanding event Scale_up and a reducing event Scale_down. N of the serving VMs is a natural number, and M of the redundant VMs is an integral greater than or equal to zero.

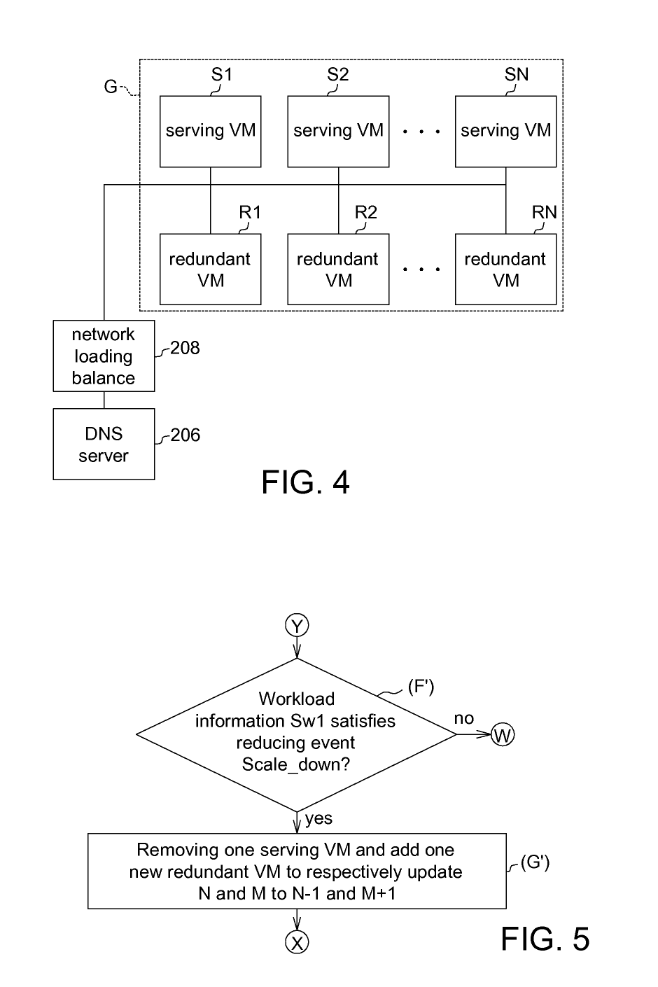

In Step (B), in response to the command CMD, the master control module 114 drives the extended cluster module 5001 to generate an extended cluster G including N serving VMs S1, S2, . . . , SN, and M redundant VMs R1, R2, . . . , RM, where N is a natural number, and M is an integral greater than or equal to zero, as shown in FIG. 4. More specifically, the N serving VMs S1 to SN are connected to an external network via a network path and correspondingly provide computing services. In contrast, the redundant VMs R1 to RM, similarly allotted with same software and connections as the serving VMs, are however in a shut-down state.

For example, the user of the virtualized server 2 is a network service provider that provides web connection services through the serving VMs S1 to SN in the virtualized server 2. Thus, the serving VMs S1 to SN are deployed with corresponding web service software programs, which provide corresponding web connection services in response to a connection request inputted by a web user via the Internet. Similarly, the redundant VMs R1 to RN are deployed with the same web service software and system settings as the serving VMs; however, all of the redundant VMs R1 to RN are in a shut-down state in the initial stage.

For example, the web service software programs and the corresponding network setting parameters of the serving VMs S1 to SN and the redundant VMs R1 to RM are stored in the database module 116. Accordingly, in Step (B), the master control module 114 accesses the database module 116 to acquire the foregoing web service software and the corresponding network setting parameters, and performs corresponding software and network allocation operations for the serving VMs S1 to SN and the redundant VMs R1 to RM by the setting module 5005.

In Step (C), in response to the command CMD, the master control module 114 drives the event module 5007 to determine an expanding event Scale_up and a reducing event Scale_down associated with the workload information Sw1 of the serving VMs S1 to SN. For example, the expanding event Scale_up is defined as the workload information indicating that the serving VMs S1 to SN are continuously at a relatively fully loaded performance for a period of time. For example, the workload information corresponding to the expanding event Scale_up is that, in a continuous period, a part or all of the average utilization rate of the virtual CPU 3001 or the virtual memory 3002, the network flow of the virtual network switch 3003 and/or the data access speed of the virtual disc 3004 of all of the serving VMs S1 to SN are continuously greater than a corresponding upper threshold.

In contrast, the reducing event Scale_down is defined as the workload information indicating that the serving VMs S1 to SN are continuously at a relatively lowly loaded performance for a period of time. For example, the workload information corresponding to the reducing event Scale_down is that, in a continuous period, a part or all of the average utilization rate of the virtual CPU 3001 or the virtual memory 3002, the network flow of the virtual network switch 3003 and/or the data access speed of the virtual disc 3004 of all of the serving VMs S1 to SN are continuously smaller than a corresponding lower threshold.

In Step (D), the system surrogate module 12 periodically provides a trigger event Et. In response to the trigger event Et, the master control module 114 detects the workload information Sw1 of the serving VMs S1 to SN. Next, in Step (E), the master control module 114 determines whether the workload information satisfies the expanding event Scale_up, i.e., the master control module 114 determines whether the serving VMs S1 to SN are continuously overloaded. When a result of Step (E) is affirmative, Steps (F) and (G) are performed, in which the master control module 114 increases the number of the serving VMs to enhance the overall computing performance of the virtualized server 2.

Further, when the workload information Sw1 satisfies the expanding event Scale_up, the management method according to this embodiment performs Step (F). In Step (F), the master control module 114 further determines whether M equals zero, i.e., the master control module 114 correspondingly determines whether the extended cluster G includes any redundant VM. When a result of Step (F) is affirmative, Step (G) is performed, in which the master control module 114 drives the VM management module 204 to activate one of the M redundant VMs R1 to RM (e.g., the redundant VM R1) as a newly-added serving VM. Thus, through the approach of adding a new serving VM, the excessive workload of the current serving VMs is further shared. For example, the master control module 114 further drives the extended cluster module 5001 to update N and M to N+1 and M−1, respectively.

FIG. 5 shows a partial flowchart of a management method according to one embodiment of the invention. After Step (E), when the workload information Sw1 does not satisfy the expanding event Scale_up, the management method according to this embodiment performs Steps (F′) and (G′), to correspondingly determine whether the workload information Sw1 satisfies the reducing event Scale_down and to correspondingly control the extended cluster G. Further, when the workload Sw1 does not satisfy the expanding event Scale_up, the management method according to this embodiment performs Step (F′), in which the master control module 114 is controlled by the trigger event Et to determine whether the workload information Sw1 satisfies the reducing event Scale_down. When the workload information Sw1 satisfies the reducing event Scale_down, Step (G′) is performed. In Step (G′), the master control module 114 drives the VM management module 204 to inactivate one of the serving VMs S1 to SN to remove one serving VM and to add a new redundant VM, so as to update N and M to N−1 and M+1.

In conclusion, through executing the management method by the management system 1 according to this embodiment, the workload of the serving VMs S1 to SN is effectively referred to selectively adjust the number of the serving VMs, thereby offering the user of the virtualized server 2 with more adaptive cloud services.

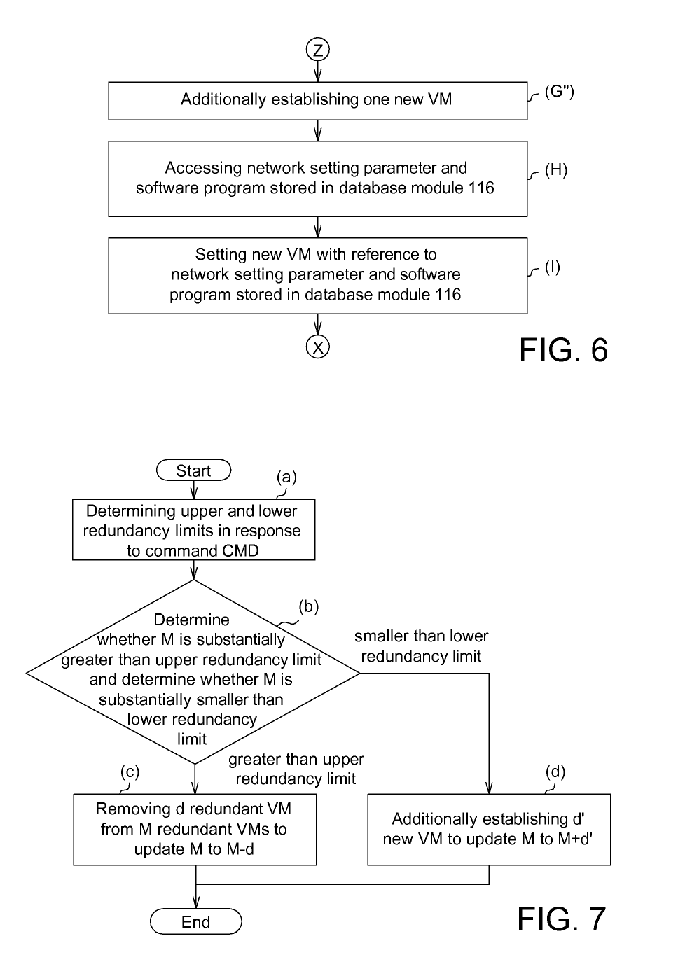

FIG. 6 shows a partial flowchart of a management method according to one embodiment of the invention. After Step (F), when M equals to zero, it means the extended cluster G contains no more inactivated redundant VM. In such situation, the management method of this embodiment correspondingly performs Steps (G″), (H) and (I) to establish a new VM by the VM management module 204. More specifically, when M equals zero, the management method of this embodiment performs Step (G″), in which the master control module 114 drives the VM management module 204 to additionally establish a new VM.

In Step (H), the master host module 114 accesses the network setting parameters and application software stored in the database module 116. For example, the database module 116 stores the setting parameters and application software corresponding to the N serving VMs S1 to SN and the M redundant VMs R1 to RM. Taking the virtualized server 2 as a web server for example, the application software may be application software for providing corresponding web services, and the setting parameters are related network parameter settings for connecting to the Internet via a Domain Name System (DNS) server 206 and a network loading balance 208. With the provision of the DNS server 206 and the network loading balance 208, a connection request sent from the Internet may be evenly distributed to the N serving VMs S1 to SN, thereby realizing optimized workload allocation for the virtualized server 2.

In Step (I), the setting module 5005 sets the newly established VM with reference to the network setting parameters and the application software stored in the database module 116. Accordingly, when all the VMs in the extended cluster G are used up, the management method of this embodiment establishes a new VM by the VM management module 204, so that the virtualized server 2 of this embodiment is offered with enhanced performance augmentation flexibilities.

FIG. 7 shows a partial flowchart of the management method according to one embodiment of the invention. Apart from the approach for expanding the extended cluster G in FIG. 6, in this embodiment, the management system 1 performs Steps (a) to (d) by the extended cluster management module 5003 to manage the extended cluster G. For example, the extended cluster management procedure in this embodiment is executed at the same time with the management method in FIG. 3.

Further, the extended cluster management procedure first performs Step (a), in which the master control module 114 determines an upper redundancy limit and a lower redundancy limit for determining a range of M. The extended cluster management module 5003 receives the upper redundancy limit and the lower redundancy limit, and determines whether M is substantially greater than the upper redundancy limit and whether M is substantially smaller than the lower redundancy limit.

When M is greater than the upper redundancy limit, it infers that the extended cluster G contains excessive redundant VMs, and Step (c) is performed. In Step (c), the extended cluster management module 5003 drives the VM management module 204 to calculate a difference d between the current M and the upper redundancy limit, and removes d redundant VMs from the M redundant VMs. In other words, the extended cluster management module 5003 updates M to M−d to correspondingly reduce the number of the redundant VMs in the extended cluster G. Conversely, when M is smaller than the lower redundancy limit, it infers that the number of redundant VMs is too small, and Step (d) is performed. In Step (d), the extended cluster management module 204 calculates a difference d′ between the current parameter M and the lower redundancy limit, and adds d′ redundant VMs. In other words, the extended cluster management module 5003 updates M to M+d′ to correspondingly complement the number of the redundant VMs in the extended cluster G.

In this embodiment, an example of the virtualized server 2 as a network server is described for illustrative purposes. It should be noted that, the virtualized server 2 is also applicable to other networking services including grid computing, cloud software services, cloud storage services and cloud social networks.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A management system, applied to a virtualized server, for managing a plurality of virtual machines (VMs) in the virtualized server, the virtualized server executing a virtualized management program to simulate the VMs, the management system comprising:
a user interface module, for providing a user interface and correspondingly generating a command in response to a user event;
a master control module, for determining an extended cluster in response to the command, and further determining an expanding event in response to the command; wherein, the extended cluster comprises N serving VMs and M redundant VMs, the N serving VMs provide a computing service via a network path, N is a natural number, M is an integral greater than or equal to zero, and the expanding event is associated with workload information of the N serving VMs;
a system surrogate module, for periodically providing a trigger event to drive the master control module to detect the workload information of the N serving VMs, and to drive the master control module to determine whether the workload information satisfies the expanding event;
wherein, when the workload information satisfies the expanding event, the master control module further determines whether M equals zero; and when M does not equal zero, the master control module activates one of the M redundant VMs to remove one redundant VM and to concurrently add a new serving VM, and updates N and M to N+1 and M−1, respectively.

2. The management system according to claim 1, wherein:
the master control module further determines a reducing event associated with the workload information in response to the command, and is controlled by the trigger event to determine whether the workload information satisfies the reducing event; and
when the workload information satisfies the reducing event, the master control unit deactivates one of the N serving VMs to remove one serving VM and to concurrently add a new redundant VM, and updates N and M to N−1 and M+1, respectively.

3. The management system according to claim 2, wherein the virtualized server further comprises a VM management module for detecting operations of the VMs to obtain the workload information.

4. The management system according to claim 1, wherein the virtualized server further comprises a VM monitoring module for detecting operations of the VMs to obtain the workload information.

5. The management system according to claim 1, wherein the master control module drives a VM management module of the virtualized server to additionally establish a new VM when M equals zero.

6. The management system according to claim 5, further comprising:
a database module, for storing a network setting parameter and application software of the N serving VMs and the M redundant VMs; and
a setting module, for performing network and software allocations for the new VM with reference to the network setting parameter and the application software.

7. The management system according to claim 6, wherein when the master control module determines the extended cluster, the setting module further performs network and software allocations for the N serving VMs and the M redundant VMs with reference to the network setting parameter and the application software.

8. The management system according to claim 1, wherein:
the master control module further determines an upper redundancy limit and a lower redundancy limit in response to the command to determine a range of M; and
the management system further comprises an extended cluster management module for receiving the upper redundancy limit and the lower redundancy limit, to correspondingly determine whether M is substantially greater than the upper redundancy limit and whether M is substantially smaller than the lower redundancy limit.

9. The management system according to claim 8, wherein when M is greater than the upper redundancy limit, the extended cluster management module drives a VM management module of the virtualized server to calculate a difference d between M and the upper redundancy limit, and further removes d redundant VMs from the M redundant VMs to correspondingly update M to M−d.

10. The management system according to claim 8, wherein when M is smaller than the lower redundancy limit, the extended cluster management module drives a VM management module of the virtualized server to calculate a difference d′ between M and the lower redundancy limit, and further adds d′ redundant servers to the extended cluster to correspondingly update M to M+d′.

11. A management method, applied to a virtualized server, for managing a plurality of VMs in the virtualized server, the virtualized server executing a virtualized management program to simulate the VMs, the management method comprising:
providing a user interface by a user interface module of the management system and correspondingly generating a command in response to a user event;
determining an extended cluster by a master control module of the management system in response to the command; wherein, the extended cluster comprises N serving VMs and M redundant VMs, the N serving VMs provide a computing service, N is a natural number, and M is an integral greater than or equal to zero;
determining an expanding event associated with workload information of the N serving VMs by the master control module in response to the command;
periodically providing a trigger event by a system surrogate module of the management system to drive the master control module to detect the workload information of the N serving VMs in response to the trigger event;
determining whether the workload information satisfies the expanding event by the master control module in response to the trigger event;
when the workload information satisfies the expanding event, determining whether M equals zero by the master control module; and
when M does not equal zero, activating one of the M redundant VMs by the master control module to remove one redundant VM and to concurrently add a new serving VM to update N and M to N+1 and M−1, respectively.

12. The management method according to claim 11, further comprising:
determining a reducing event associated with the workload information by the master control module in response to the command;
determining whether the workload information satisfies the reducing event by the master control module in response to the trigger event; and
when the workload information satisfies the reducing event, deactivating one of the N serving VMs by the master control module to remove one serving VM and to concurrently add a new redundant VM to update N and M to N−1 and M+1, respectively.

13. The management method according to claim 12, wherein the step of determining whether the workload information satisfies the reducing event further comprises:
detecting operations of the VMs by a VM monitoring module of the virtualized server to obtain the workload information.

14. The management method according to claim 11, wherein the step of determining whether the workload information satisfies the expanding event further comprises:
detecting operations of the VMs by a VM monitoring module of the virtualized server to obtain the workload information.

15. The management method according to claim 11, further comprising:
driving a VM management module of the virtualized server by the master control module to additionally establish a new VM when M equals zero.

16. The management method according to claim 15, further comprising:
accessing a database module of the management system by the master control module, the database storing a network setting parameter and application software of the N serving VMs and the M redundant VMs; and
performing network and software allocations for the new VM by a setting module of the management system with reference to the network setting parameter and the application software.

17. The management method according to claim 16, wherein the step of determining the extended cluster by the master control module further comprises:
performing network and software allocations for the N serving VMs and the M redundant VMs by the setting module with reference to the network setting parameter and the application software.

18. The management method according to claim 11, further comprising:
determining an upper redundancy limit and a lower redundancy limit by the master control module in response to the command to determine a range of M; and
determining whether M is substantially greater than the upper redundancy limit and whether M is substantially smaller than the lower redundancy limit by an extended cluster management module of the management system.

19. The management method according to claim 18, further comprising:
when M is greater than the upper redundancy limit, driving a VM management module of the virtualized server by the extended cluster management module to calculate a difference d between M and the upper redundancy limit; and
removing d redundant VMs from the M redundant VMs by the VM management module to correspondingly update M to M−d.

20. The management method according to claim 18, further comprising:
when M is smaller than the lower redundancy limit, driving a VM management module of the virtualized server by the extended cluster management module to calculate a difference d′ between M and the lower redundancy limit; and
adding d′ redundant VMs to the extended cluster by the VM management module to correspondingly update M to M+d.
